(19) United States
(12) Patent Application Publication
(10) Pub. No.: US 2019/0204108 A1
(43) Pub. Date: Jul. 4, 2019

(54) METHODS AND APPARATUS FOR IMPROVED NAVIGATION NOTIFICATION BASED ON LOCALIZED TRAFFIC FLOW

(71) Applicant: PCMS Holdings, Inc., Wilmington, DE (US)

(72) Inventors: Giacomo Benincasa, Gainesville, FL (US); Niranjan Suri, Pensacola, FL (US); Serhad Doken, Chester Springs, PA (US)

(21) Appl. No.: 16/330,341

(22) PCT Filed: Sep. 14, 2017
(86) PCT No.: PCT/US2017/051572

§ 371 Date: Mar. 4, 2019

Related U.S. Application Data
(60) Provisional application No. 62/399,075, filed on Sep. 23, 2016.

(51) Int. Cl. G01C 21/36; G08G 1/0967; H04W 4/46

(52) U.S. Cl. CPC G01C 21/3658; H04W 4/46; G08G 1/096766; G01C 21/3655

(57) ABSTRACT

The disclosure pertains to methods and apparatus for improved navigation notification based on localized traffic flow. A navigation system may comprise a transmitter, a receiver, and a processor, coupled to the transmitter and the receiver. The processor may be configured to determine a current lane position of the first vehicle, determine a target lane position for the first vehicle as a function of a navigation event point, determine a distance to the navigation event point, determine an alert time based on an estimate of traffic density, and provide an alert associated with the target lane position at the alert time. The estimate of traffic density may be based on traffic conditions in lanes between the current lane position and the target lane position and the distance to the navigation event point.

### CROSS REFERENCE TO RELATED APPLICATIONS

This application claims priority from U.S. Provisional Patent Application No. 62/399,075 filed on Sep. 23, 2016, the contents of which are hereby incorporated herein by reference as if fully set forth.

### FIELD

This application relates to assisted navigation for vehicles.

### BACKGROUND

Global positioning system (GPS) navigation systems may offer turn-by-turn instructions based on location of a vehicle being guided and known road maps.

The GPS-navigation systems, however, do not consider localized traffic micro-conditions and do not take traffic-conditions into consideration for turn-by-turn instructions. Traffic conditions are currently considered to suggest alternative routes.

### SUMMARY

Methods, apparatuses, and systems for a navigation system of a first vehicle executing improved navigation alert notification are provided. A navigation system may comprise a transmitter, a receiver, and a processor, coupled to the transmitter and the receiver. In one embodiment, the navigation system may be configured to determine a first lane position of a first vehicle, determine a target lane position for the first vehicle as a function of a navigation event point, determine a distance of the first vehicle to the navigation event point, determine an alert time based on an estimate of traffic density, and provide an alert associated with the target lane position at the alert time. The estimate of traffic density may be based on traffic conditions in one or more lanes between the first lane position and the target lane position and the distance of the first vehicle to the navigation event point.

### BRIEF DESCRIPTION OF THE DRAWINGS

A more detailed understanding may be had from the detailed description below, given by way of example in conjunction with drawings appended hereto. Figures in description, are examples. As such, the Figures and the detailed description are not to be considered limiting, and other equally effective examples are possible and likely. Furthermore, like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 shows a representative message transaction diagram according to a gossip-based aggregation (GbA) algorithm in a vehicular network in accordance with a representative embodiment;

FIG. 3A is an illustrative bird's eye view of a representative portion of a road network;

FIG. 3B is an illustrative counter table based on each lane and section, and average speed of vehicles in each lane in accordance with FIG. 3A;

FIG. 4 is a flowchart illustrating a representative method in accordance with an embodiment;

FIG. 5 is a flowchart illustrating another representative method in accordance with an embodiment;

FIG. 6 is a flowchart illustrating a further representative method in accordance with an embodiment;

FIG. 7 is a flowchart illustrating an additional representative method in accordance with an embodiment; and

FIG. 8 is a flowchart illustrating a still further representative method in accordance with an embodiment.

### DETAILED DESCRIPTION

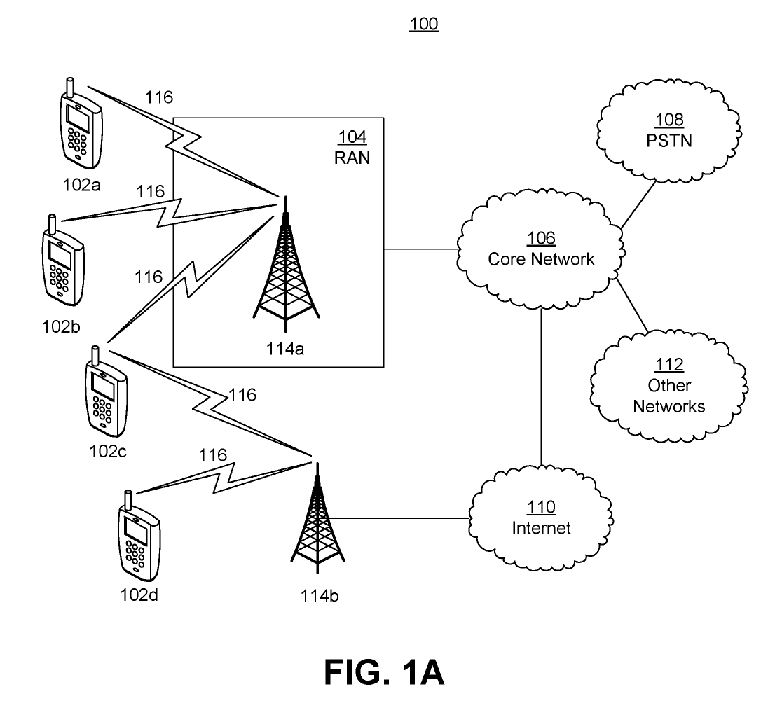

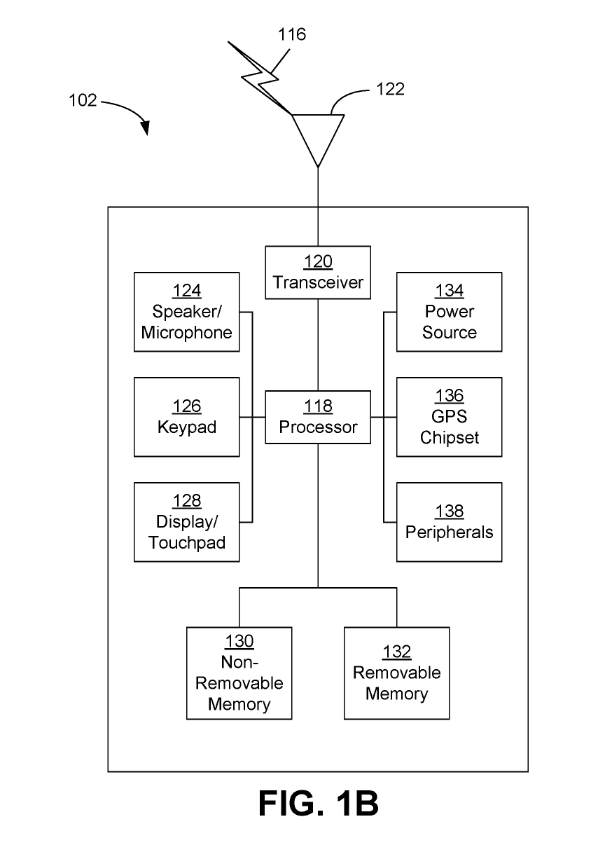

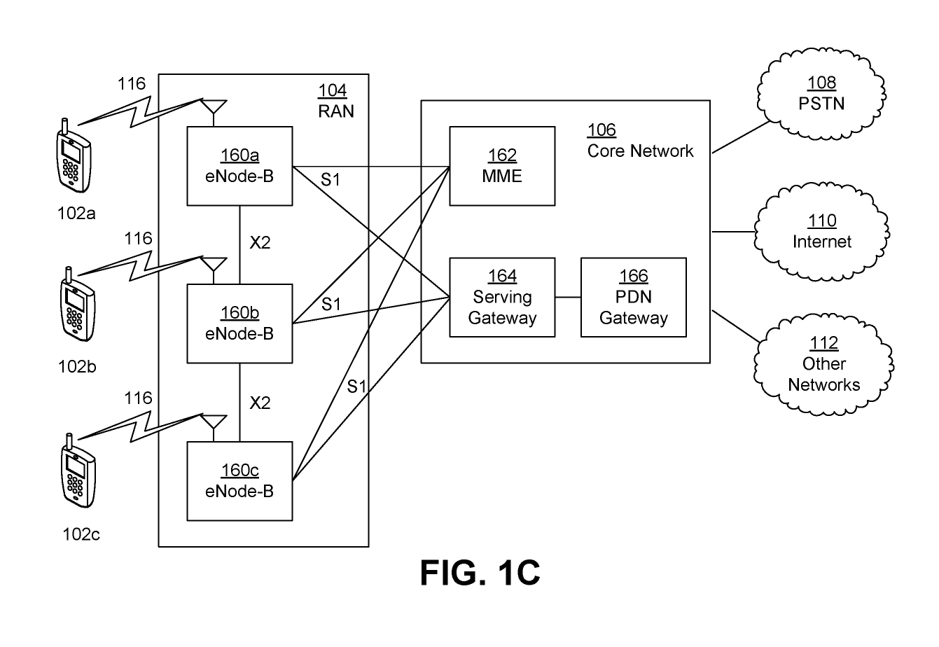

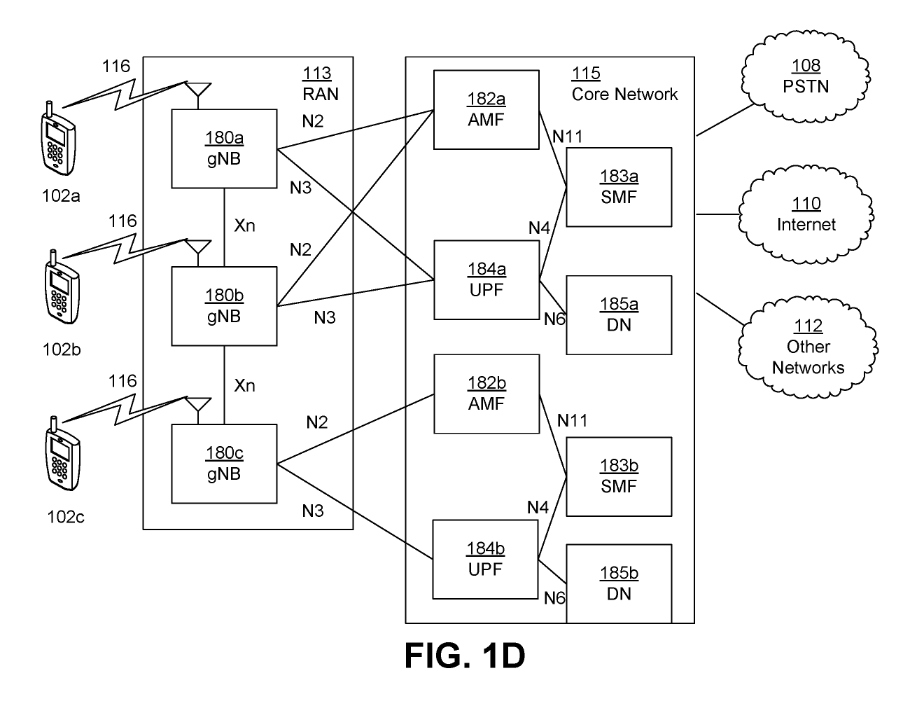

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit (not shown) to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11 af and 802.11 ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11 ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

GPS navigation systems may offer turn-by-turn instructions based on detailed knowledge of road maps, precise knowledge as to the location of the vehicle being guided, and current traffic-conditions. Traffic conditions may be obtained directly from road side infrastructure such as cameras, pressure pads, roadside radars, etc. and/or indirectly, such as by examining density of mobile phone users. These techniques can provide real-time, macroscopic traffic data. Alternatively, distributed, node-counting techniques that rely on vehicle to vehicle (V2V) communications for determining traffic patterns may be implemented. Such infrastructure-less techniques are usually best suited to estimating an environment locally. Some of these techniques/operations include local probing to determine a number of vehicles located in proximity to a probing vehicle and subsequent dissemination of the estimation in order to estimate total size of a network. A local size of the network may be estimated by if vehicle distribution matches a certain statistical model. In addition to or in lieu of an estimate of the size of the network, the size of a local neighborhood may be estimated taking into consideration any of: (1) vehicle speed, (2) acceleration patterns and/or (3) deceleration patterns. A peer-to-peer (P2P) distributed algorithm may be used for infrastructure-less vehicle density estimation in highly mobile vehicular ad hoc network (VANET), for instance, a gossip-based aggregation (GbA) algorithm.

Although a gossip procedure/operation/function is disclosed herein, other procedures/operations/functions are equally applicable, for example to estimate traffic density. In some embodiments, for example traffic density may be estimated using one or more roadside devices (e.g., a road side infrastructure including one or more cameras, and/or other sensors such as sensors capable of counting moving vehicles, for example lidar devices, radar devices, IR sensor devices, and/or RF scanning devices, among others). The infrastructure may be deployed in the vicinity of the road (e.g., at or near the side of the road). Traffic density may be estimated using data collected from a plurality of devices (e.g., in-vehicle devices and/or road side devices) and/or the traffic density may be provided by a centralized server. For example, vehicles may transmit their location information and other information (e.g., speed of a vehicle, and/or lane ID, etc.) to the centralized server. The centralized server may calculate traffic density based on the received information and provide the traffic density (e.g., via wireless communications) to any number of vehicles that may use the traffic density. One of skill understands that any number of these traffic density estimate procedures/operations/functions may be combined, for example, to reduce/optimize processing requirements, to reduce/optimize bandwidth requirements, and/or to improve the accuracy of the traffic density among others.

Detection of the roads and lanes that a vehicle is in may be implemented. For instance, numerous computer-vision-assisted methods and a consensus algorithm may be implemented. For example, a consensus algorithm may allow nearby vehicles to adjust their GPS position estimate by an offset that is computed in a distributed fashion by the vehicles. Vehicles' speeds may be compared to values of average speed for each lane to better identify the lanes that the vehicles are in.

It may be useful and/or desirable to know traffic conditions in a small localized area (micro traffic conditions). Such information can be beneficially used in many ways, including, but not limited to, improving turn-by-turn navigation assistance in motor and other vehicles. In some representative embodiments, knowledge of micro traffic conditions can be used in a vehicular navigation system, such as a GPS-based navigation system, to regulate the timing of providing navigational instructions to a driver. For example, in heavier micro traffic conditions, an instruction may be issued to make an upcoming turn earlier (e.g., when the vehicle is a dynamically determined distance based on traffic conditions and/or congestion (e.g., one mile) before the turn) than in lighter micro traffic conditions (in which case, the navigation system might issue the instruction when the vehicle is V2 mile before the turn). Alternately or additionally, the navigation system may take into consideration the lane in which the vehicle is travelling relative to the lane from which the turn is to be made when making navigational decisions (such as when to issue a particular instruction).

In some representative embodiments, a vehicle may be able to detect the lane that the vehicle is currently in or to receive lane identity (ID) information from a lane detector. The vehicle may provide the lane ID information to a navigation system. This lane ID information can be used by the navigation system to improve directions by suggesting to move to another lane before a turn if the vehicle is not in a correct and/or optimum lane.

In some representative embodiments, a vehicle may determine its location, for example, via global positioning system (GPS) coordinates, assisted roadside unit localization, and/or vehicle assisted localization techniques/operations. The vehicle may provide its location information to a navigation system. The navigation system may recommend one or more specific lanes to be used for turning based on the location information. In some representative embodiments, if a vehicle is determined to be in the rightmost lane based on the location information, the navigation system may not provide a recommendation, which may help reduce signaling overhead. Alternatively, or additionally, if a driver announces a change of a lane by setting a blinker, the navigation system may provide a recommendation to stay in the current lane.

In some representative embodiments, a GbA algorithm may be employed to determine certain micro traffic conditions, for example localized traffic density data and/or lane-specific traffic density, for example to provide enhanced navigational instructions.

It is contemplated that in certain representative embodiments that the vehicles participating in gossip exchange may be aware of the particular lane in which the vehicles are driving and/or that the GbA algorithm in accordance with the principles disclosed herein may be running on each vehicle participating in a gossip exchange. In at least some embodiments, it is contemplated that vehicles may be aware of the average speed of traffic flow in at least one traffic lane. Average speed of traffic flow may be obtained by periodic exchange of cooperative awareness messages (CAMs) that include speed information of vehicles. The clocks of the various vehicles participating in a GbA algorithm may be synchronized and/or unsynchronized. Clock synchronization between or among vehicles may be realized, for example, when vehicles equipped with cellular connections and/or linked to smartphones connect to a network time protocol (NTP) server.

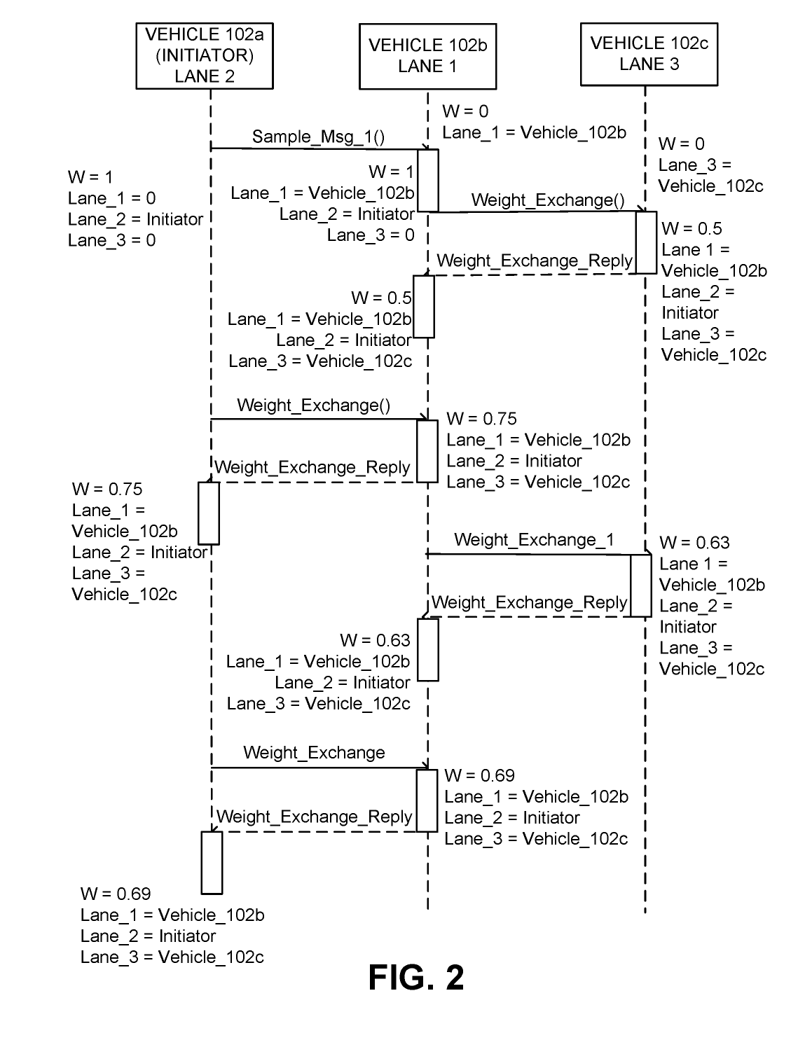

In accordance with representative embodiments, a GbA algorithm is disclosed herein that attempts to estimate a total number of vehicles in a region (e.g., only a region) along a path that the vehicle is driving (hereinafter termed the “area of interest”), rather than the number of vehicles in the entire network. The region may be an area surrounding a particular vehicle. For example, the area of interest may include an area within a certain distance of the vehicle, including at least one of: in front of the vehicle, in the rear of the vehicle, to the right of the vehicle, and/or to the left of the vehicle. The area of interest may be sized and/or determined based on a size of a vehicular network. The size of the vehicular network may be determined based on a number of detected vehicles and a converged weight value. The converged weight value may be determined by repeating a gossip process/operation as described in connection with FIG. 2 and FIGS. 4-8. The area of interest may be sized and/or determined by taking into account and/or determining the complexity of a vehicular network. Various information may be used to evaluate the complexity of the vehicular network, for example, a number of streets, a number of junctions, a number of navigation beacons, and/or a vehicular density.

The area of interest for which a number of vehicles is sampled or estimated may be divided into a grid (e.g., a two (or more)-dimensional grid), e.g., based on horizontal “sections” and/or vertical “lanes.” Alternatively or additionally, the area of interest for which a number of vehicles is sampled or estimated may be divided into one or more longitudinal sections of roadway and/or one or more traffic lanes. The longitudinal sections may be virtually delimited stretches of road, while the lanes may correspond to actual road lanes. The area of interest may be overlaid with a “virtual grid.” The GbA algorithm may attempt to estimate or sample a number of vehicles in each section of the virtual grid. Each section may be determined in various lengths. The sum of the vehicles in each grid may correspond to a size of a vehicular network (and may determine the traffic density in that section of the grid).

FIG. 2 shows a representative message transactions executing a GbA algorithm in accordance with a representative embodiment. In the vehicular network, each vehicle or each WTRU (e.g., vehicles 102a-102c) may communicate with at least one satellite to determine its location (e.g., in the form of GPS coordinates of a WTRU). The determination of the location of the vehicle may use or may be assisted via roadside unit localization, and/or via vehicle assisted localization techniques. A GPS or other global navigation satellite system (GNSS) unit or chipset may be implemented in a vehicle or WTRU and may be connected to an antenna to exchange signals for navigation. Alternatively or in combination with the communications with at least one satellite, a WTRU may be configured to communicate with one or more other WTRUs in P2P networking. A vehicle (e.g., some or each WTRU) (e.g., vehicle 102a, 102b, or 102c) may count a number of vehicles in a lane (e.g., each lane) in an area of interest and/or may measure the speeds of the vehicles. A WTRU (e.g., each WTRU) may communicate with at least one other WTRU in a vehicular network, e.g., via a cellular or a wireless network including IEEE Std 802.11™ which may comply with Standard Specification for Telecommunications and Information Exchange Between Roadside and Vehicle Systems—5.9 GHz Band Wireless Access in Vehicular Environments (WAVE) and Dedicated Short Range Communications (DSRC).

FIG. 2 shows an example in which multiple vehicles (e.g., three vehicles) are in an area of interest (e.g., vehicle 102a in lane 2, vehicle 102b in lane 1, and vehicle 102c in lane 3) and one of the vehicles is an initiator (e.g., vehicle 102a in lane 2) in a vehicular network. In accordance with this GbA algorithm, the vehicles (e.g., each vehicle) is to be assigned a weight as described in detail below. The initiator vehicle 102a may generate and may send a Sample message to at least one vehicle in its vicinity, e.g., using a short-range communication protocol such as the aforementioned IEEE 802.11 WAVE protocol, or otherwise restricting the message to vehicles within a certain range of the initiator. In representative embodiments, the at least one vehicle that receive a sample message may initially assign itself a weight of 1, as does the initiator vehicle. The Sample message may be received by K−1 vehicle(s). In this simple example of FIG. 2, the Sample message may be received by one vehicle (e.g., vehicle 102b). Hence, K=2, which represents the number of vehicles that initiated their weights to 1, namely, the K−1 vehicles that received a Sample message plus the initiator vehicle 102a. The initial K vehicles (102a and 102b) may start exchanging their current weights with other vehicles using, for example a Weight_Exchange message. For instance, after having received the Sample message, the vehicle 102b may send its initial weight value of 1 to vehicle 102c via a Weight_Exchange message. Upon receipt of the Weight_Exchange message, the vehicle 102c may calculate a new weight for itself by averaging a previous weight of the vehicle 102c (0 initially) with the weight of the vehicle 102b that the vehicle 102c received in the Weight_Exchange message. The vehicle 102c may update its weight value to “0.5” by averaging its current weight value “0” with the received weight value “1” of the vehicle 102b. The vehicle 102c may reply to the vehicle 102b with its updated weight value, “0.5,” via a Weight_Exchange_Reply message, and the vehicle 102b may set its own weight to 0.5, as well. The process of exchanging messages with neighboring vehicles (e.g., only with neighboring vehicles) is referred to generally as gossiping. The gossiping is repeated on the vehicles (e.g., each vehicle (e.g., 102a, 102b, 102c)). The gossiping may be repeated at certain intervals. The intervals may be preconfigured in the GbA algorithm, signaled and/or configurable by a user.

For example, after an interval, the initiator vehicle 102a may send its weight value, “1,” to the vehicle 102b again via a Weight_Exchange message. Upon receipt of the Weight_Exchange message, the vehicle 102b may update its weight value to “0.75” by averaging its current weight value “0.5” with the received weight value “1” of the initiator. The vehicle 102b may reply to the vehicle 102a with an updated weight value, “0.75,” via a Weight_Exchange_Reply message.

Subsequently, the vehicle 102b may send to the vehicle 102c a modified weight value “0.75” via a Weight_Exchange message. Upon receipt of the Weight_Exchange message, the vehicle 102c may update its weight value to “0.63” by averaging its current weight value “0.5” with the received weight value “0.75” of the vehicle 102b. The vehicle 102c may reply with its updated weight value, “0.63,” to the vehicle 102b via Weight_Exchange_Reply.

After another interval, the initiator vehicle 102a may send its current weight value, “0.75,” to the vehicle 102b (e.g., yet again) via another Weight_Exchange message. Upon receipt of this Weight_Exchange message, the vehicle 102b may update its weight value to “0.69” by averaging its current weight value, “0.63,” with the received weight value “0.75” of the initiator vehicle 102a. The vehicle 102b may again reply with its updated weight value, “0.69,” to the initiator vehicle 102a via a Weight_Exchange_Reply message.

Through this gossip process/operation, the weights assigned to the vehicles (e.g., all of the K vehicles) in the gossip group may eventually converge to the same value, that value being between 0 and 1. In the representative embodiment of the vehicular network in FIG. 2, the weight value assigned to a vehicle (e.g., each vehicle) eventually may converge to “0.66,” e.g., by averaging the last weight value “0.69” of the vehicle 102b and the last weight value “0.63” of the vehicle 102c.

Depending on the number of vehicles participating in the GbA, the value to which the weights of the vehicles (e.g., all of the vehicles) in the gossip group converges may be different. For example, the algorithm may be halted when the change in the weights between several consecutive iterations becomes less than a predetermined threshold. A size of the local vehicular network (e.g., the traffic density) may be calculated as the number of vehicles, K, in the gossip group divided by the converged average weight value. The size of the vehicular network in FIG. 2 may become 3.03 (=2/0.66), which is approximately 3. This is indicative of the traffic density when (1) the size of the geographic area covered by the gossip group is reasonably well defined, such as by knowing the range of the communication protocol used for exchanging the Sample messages and weigh exchange messages and replies and/or (2) a reasonable assumption can be made about the percentage of vehicles in the vicinity that are equipped to participate in gossip groups. It may not be necessary that all relevant vehicles be equipped to send an acknowledgment to the Sample message and participate in a gossip group, as long as a reasonable assumption/determination can be made as to the percentage of vehicles that are and/or are not so equipped.

In some representative embodiments, the above-GbA algorithm may be modified to achieve an even more fine-grained estimation of traffic. For example, when a vehicle sends either a Sample or a Weight Exchange message to one or more other vehicles in an area of interest, a reply message to the Sample or the Weight_Exchange message may be generated to include location information of the particular other vehicle, speed of the vehicle, the lane that the vehicle is currently in, and a timestamp indicating the time the reply to the probing message was sent. By using this additional information, in addition to or in lieu of determining localized traffic density, vehicles may be able to create a local map of their surrounding (e.g., immediate and/or adjacent surroundings), showing the actual locations of other vehicles in their vicinity. These maps may be represented in counter tables where the rows represent longitudinal sections of roadway, and the columns represent the lanes. By sharing the counter tables, other vehicles may adjust the density estimation of a larger area to a smaller section of the roadway. This additional information may be embedded into the Sample messages, Weight_Exchange messages and/or the reply messages or may be sent in a separate message.

The location information, speed, and/or lane identity information may be used to update a number of vehicles in one or more lanes (e.g., each lane) within an area of interest surrounding the initiator (e.g., the vehicle 102a). For example, the vehicle 102b may locally maintain a counter table. When receiving a reply to the Sample or Weight_Exchange message from at least one neighbor vehicle, e.g., the vehicle 102c in FIG. 2, the vehicle 102b may check or extract, from the reply to the Sample or Weight_Exchange message, the location information, speed, and/or lane identity information of the vehicle 102c.

The vehicle 102b may update its counter table as illustrated in Table A based on the received location information, speed, and/or lane identity information of vehicle 102c in one or more areas of interest (e.g., 0-100 meters and/or 100-200 meters ahead of, behind, to the left of, and/or to the right of vehicle 102b).

TABLE A

| | | Lane 1 | Lane 2 | Lane 3 | Lane 4 |
|---|---|---|---|---|---|
| 0-100 | meters | 3 vehicles | 1 vehicles | 0 vehicles | 1 vehicles |
| 100-200 | meters | 2 vehicles | 0 vehicles | 1 vehicles | 0 vehicles |

A vehicle (e.g., each vehicle 102b or 102c) may use a set of equations to build a counter table, such as Table A, based on the received Weight_Exchange_Reply messages that may include any of: one or more locations, one or more speeds, and one or more timestamps. For instance, if the vehicle 102b received an extended Weight_Exchange_Reply message 2 seconds after the vehicle 102c sent the extended Weight_Exchange_Reply message, at a sending time, the vehicle 102b may be trailing the vehicle 102b by 100 meters, and the vehicle 102b may be travelling 5 km/h faster than vehicle 102c. A current distance between the two vehicles 102b and 102c can be calculated based on the following Equation 1:

distance_{new}=distance_{old}+|v_{vehicle1}−v_{vehicle2}|×time. (1)

The approximate current distance between the two vehicles 102b and 102c may be 228 meters based on the following calculation:

$$distance = 200 + 5 \frac{{10}^{3}}{{60}^{2}} 2 = 200 + \frac{1000}{36} ∼ 228 meters . \qquad ( 2 )$$

The calculation may take into account and/or determine a shape of a road in determining a current distance (e.g., because inside lanes will be shorter than outside lanes on a curve). It is contemplated that vehicles are relatively close to each other, and on parallel lanes of the same road, if not the same lane, and because speed difference of the vehicles is expected to be limited, the above equation may generate an acceptable approximation of an actual distance of the two vehicles without factoring in road shape. Also, the above equation may not take into account and/or determine variations in acceleration of the two vehicles. Because propagation time of the exchanged messages is contemplated to be small (e.g., on the order of a fractions of a second), and because the vehicular network is more likely to be useful in heavy traffic conditions, it is contemplated that errors introduced by omitting the acceleration factor may be negligible.

At each point in time, the sum of the vehicles (e.g., all of the vehicles) in the counter table and the estimate of total number of vehicles computed using the GbA algorithm may be conflicting. The counter table is likely to be more inaccurate than the output of the GbA algorithm because of the several approximations previously described. If that happens, the two values can be reconciled by normalizing the elements of the table with the output of the GbA algorithm. For example, the elements (e.g., each element) of the counter table can be multiplied by a scaling factor Sc defined in Equation 3 as follows:

$$Sc = \frac{{GbA}_{output}}{Sum of all the counters in the table} \qquad ( 3 )$$

The estimate of a number of vehicles of any sub-area of the area of interest can be computed using any analogous methodology.

Depending on the characteristics of a communication equipment embedded in a vehicle and/or on the complexity of a vehicular network, the above-GbA algorithm may be applied to a geographic area that is smaller than the area of interest of a vehicle. In certain representative embodiments, a vehicle may request counter tables computed by other known vehicles that are located as far as possible from the vehicle, for example to maximize the area over which the vehicle obtains surrounding traffic density knowledge. The counter tables may be transmitted in a normalized format.

For instance, a vehicle in a rightmost lane receiving an aggregate message may assume that, by the time the message was delivered, the vehicles that were traveling in the leftmost lane have moved farther away. By taking into account: (1) delivery time, (2) relative speed of the vehicles in different lanes, (3) a length of the sections, (4) an average length of a vehicle and/or (5) a distribution of the vehicles in a lane (e.g., a uniform distribution over a length of the lane, counters in the received counter table may be adjusted, and/or counters of the local table may be updated, for example using this adjusted counters).

For example, the data included in and/or contained in counter tables received from other vehicles may overlap with the data in the local table (or data in counter tables received from yet other vehicles, e.g., multiple vehicles have data for overlapping geographic areas. If the normalized values in the received counter tables conflict with corresponding values in a local counter table in overlapping geographic sections, such a conflict may be resolved by computing an average of the corresponding values. Other conflict resolution techniques may be implemented. For example, (1) newly computed values may be given a higher weight than older, and more likely to be stale, values; (2) overlapping tables where two sets of corresponding values are not in conflict may be given higher weight than a third table having a third set of corresponding values that are in conflict with the two non-conflicting sets of such values; and/or (3) information from sources determined to be less reputable may be given a lower weight.

The area of interest is not contemplated to be extensive, and the number of lane may be limited, for example to number smaller than 10 and the counter table is not contemplated to be too large. Alternatives to sending the whole table may also be utilized including sending updated information (e.g., only updated information) and/or sending a portion of a table (e.g., information associated with a section and/or a lane).

In some representative embodiments, a navigation recommendation may be improved by taking the density information of the vehicles in the individual lanes between the lane that the turning vehicle is driving in and the closest lane that allows for the vehicle to turn, such as may be derived from the aforementioned GbA algorithm. For instance, when a vehicle desires and/or needs to turn, the vehicle may use estimated density on a per lane basis to compute and/or determine a likelihood of finding some space to change lanes. The density may be computed by counting (e.g., summing all) the vehicles in the desired lane that are in the geographic sections that are between the current position of the turning vehicle and the location of the turn, by multiplying this count/sum by the average length of a vehicle, and by dividing the result by the length of the road between the current position of the turning vehicle and the turn. Depending on the likelihood of finding space to change a lane, the navigation system may issue an appropriate recommendation and/or instruction, for example, to stay in the current lane or to move a lane to the right or to the left. The information may be used to determine how soon a recommendation or instruction is to be and/or will be issued.

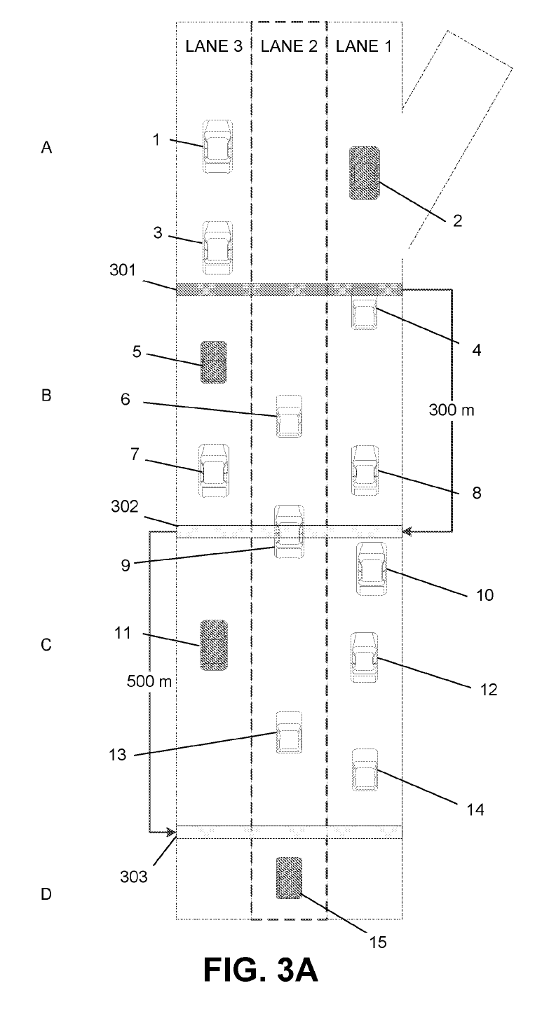

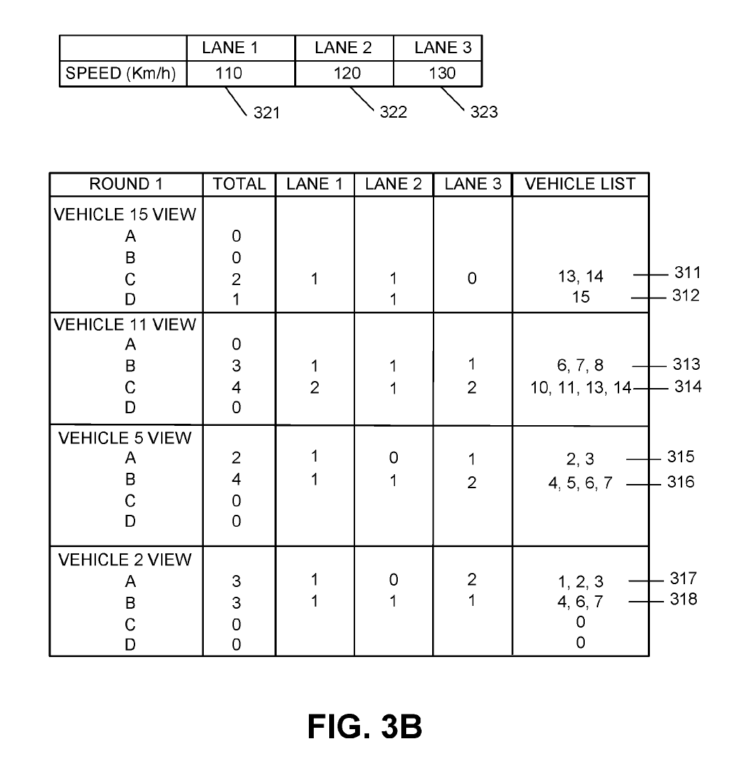

FIGS. 3A and 3B illustrate a micro traffic condition that may exist on a roadway and the counter table that may be generated from the micro traffic condition according to an embodiment.

FIG. 3A is an illustrative aerial view of a representative portion of a road network. As shown in FIG. 3A, there are a plurality of lanes (e.g., three lanes, lane 1-lane 3) on one directional road. A certain area may be determined, which is referred to as the area of interest. Vehicles (e.g., all vehicles) may be identified in lanes (e.g., each lane) in the area of interest. For example, vehicles 2, 4, 8, 10, 12, and 14 may be identified in lane 1, vehicles 6, 9, 13, and 15 may be identified in lane 2, and/or vehicles 1, 3, 5, 7, and 11 may be identified in lane 3. The area of interest may be divided into a plurality of subsections. The horizontal lines, e.g., 301-303, in FIG. 3A delimit the different sections, e.g., section A to section D. The sections A-D (e.g., each section A-D) may be the same length or some or all of the sections may be different lengths. For example, section B may be 300 m in length and section C may be 500 m in length. A first horizontal line 301 may delimit a border between sections (e.g., sections A and B) and may indicate a geographic area positioned ahead of vehicle 9 (e.g., and the last useful point to change a lane to turn right at the next turn. A second horizontal line 302, may delimit a border between sections (e.g., sections B and C) and may indicate the current position of vehicle 9. A third horizontal line 303 may delimit a border between sections (e.g., sections C and D) and may indicate a geographic area positioned behind vehicle 9. FIG. 3B is an illustrative counter tables based the vehicles shown in FIG. 3A. A first counter tables illustrate traffic in lanes and section (e.g., in each lane and each section) of FIG. 3A. A second counter table illustrates average speed of vehicles in lanes (e.g., each lane) in accordance with FIG. 3A. In one representative embodiment, a location of vehicle 15 may be identified in lane 2 and section D. From a view of vehicle 15, two vehicles are identified in section C, e.g., vehicle 13 in line 2 and vehicle 14 in line 1, at 311. Vehicle 15 itself is identified in lane 2 and section D, at 312. It is contemplated that, in this example, some vehicles may not be detectable by the sensors of the vehicle 15. For instance, one or more vehicles (e.g., vehicle 14) surrounded by and/or within sensor range of a vehicle (e.g., vehicle 15) may not: (1) be equipped with a GbA algorithm to receive a weight value from another vehicle, (2) provide its weight value, and/or (3) calculate a new weight value by averaging the two weight values. One or more vehicles (e.g., vehicle 14) surrounded by and/or within sensor range of a vehicle (e.g., vehicle 15) may not be able to provide at least one of its location, its speed and/or a time stamp of a message being sent. For another example, there may be some communication errors between the vehicles participating in the GbA (e.g., lack of radio signal strength, and/or encoding or decoding errors in messages transmitted between the vehicles).

Although lack of data or inaccurate data in a received counter table are possible, the possibilities may be relatively low and the collected data from the vehicles participating in the GbA may be good enough to: (1) estimate a size and/or a density in a vehicular network and/or (2) determine a desired target lane position for an upcoming exit, for example to provide a guidance alert based on the determined desired target lane position.

From a view of vehicle 11, three vehicles may be identified in section B, e.g., the vehicle 8 in lane 1, the vehicle 6 in lane 2, and the vehicle 7 in lane 3, at 313. Also, four vehicles may be identified in section C, e.g., the vehicles 10 and 14 in lane 1, the vehicle 13 in lane 2, and the vehicle 11 in lane 3, at 314.

From a view of vehicle 5, two vehicles may be identified in section A, e.g., the vehicle 2 in lane 1 and the vehicle 3 in lane 3, at 315. Also, four vehicles may be identified in section B, e.g., the vehicle 4 in lane 1, the vehicle 6 in lane 2, and the vehicles 5 and 7 in lane 3, at 316.

From a view of vehicle 2, three vehicles may be identified in section A, e.g., the vehicle 2 in lane 1 and the vehicles 1 and 3 in lane 3, at 317. Also, three vehicles may be identified in section B, e.g., the vehicle 4 in lane 1, the vehicle 6 in lane 2, and the vehicle 7 in lane 3, at 318.

In some representative embodiments as illustrated in FIG. 3B, the average speed of the vehicles in a lane (e.g., each lane) in an area of interest may be identified. For example, the average speed of vehicles, e.g., of the vehicles 2, 4, 8, 10, 12, and 14 in lane 1 may be identified as 110 km/h at 321, the average speed of vehicles, e.g., of the vehicle 6, 9, 13, and 15 in lane 2 may be identified as 120 km/h at 322, and the average speed of vehicles, e.g., of the vehicle 1, 3, 5, 7, and 11 in lane 3 may be identified as 130 km/h at 323.

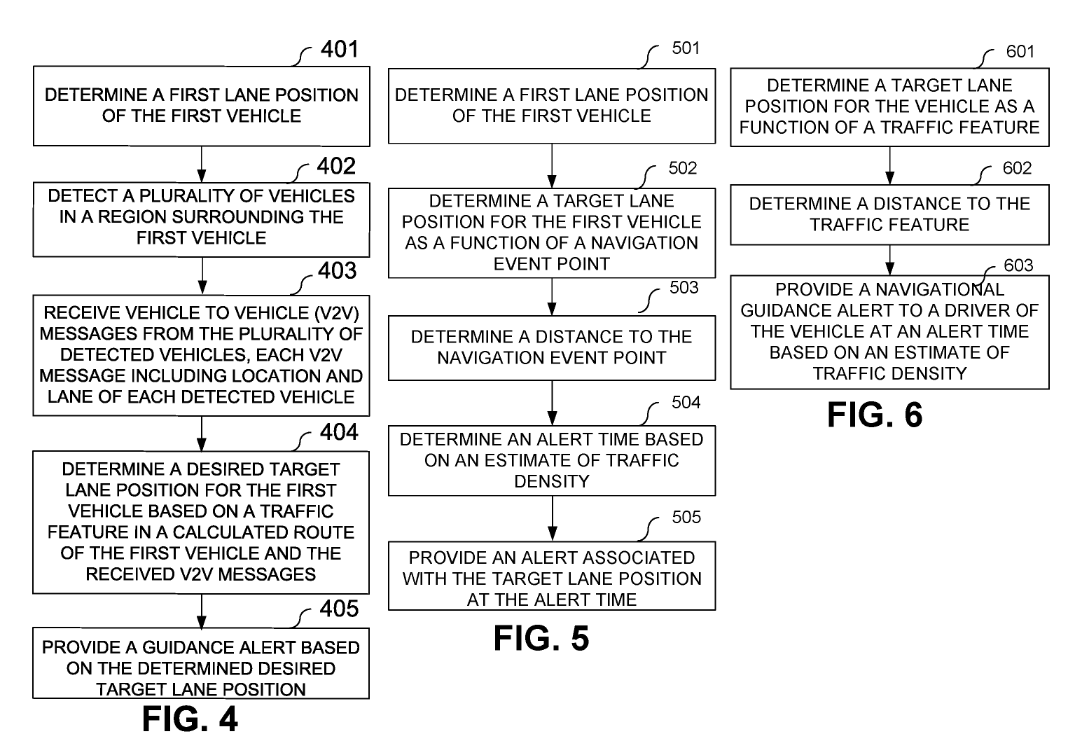

FIGS. 4-8 show flowcharts illustrating representative methods in accordance with various embodiments. The methods may be performed by any device performing navigation functions, e.g., a navigation system. The navigation system of a vehicle in a vehicular network may include a transmitter, a receiver, and a processor to perform the representative methods. One or more operations in each representative method may be performed in any combination with one or more other operations in another representative method.

FIG. 4 is a flowchart illustrating a representative method in accordance with an embodiment. A navigation system of a first vehicle in a vehicular network may include a transmitter, a receiver, and a processor to provide a guidance alert based on a localized traffic flow.

The navigation system may determine a first lane position (e.g., current lane position) of the first vehicle at operation 401. To determine a lane positon, in some representative embodiments, in addition to or in lieu of GPS, vehicles may be equipped with multiple sensors, such as modular and/or stereo cameras, LIDAR (Light Detection and Ranging), a vehicle odometer and/or inertial measurement units (IMU). Measurements, for example from the sensors, may be integrated with GPS position data and digital maps to provide positioning data accurate enough, for example to allow a vehicle to detect the lane in which the vehicle is currently located and/or driving. In some representative embodiments, a consensus algorithm may be used that allows nearby vehicles to adjust their GPS position by an offset that is computed in a distributed fashion by the vehicles, for example to achieve more accurate lane detection. In some representative embodiments, nearby vehicles may compare speeds to values of average speed for a lane (e.g., each lane), for example to identify or to better identify the lanes that the vehicles are in. The first lane position may be determined by at least one of: (1) global positioning system (GPS) coordinates, (2) assisted roadside unit localization techniques/operations, and/or (3) vehicle assisted localization techniques/operations.

At operation 402, the navigation system may detect a plurality of vehicles in a region surrounding the first vehicle. The region may be divided into one or more sections. The one or more sections may include one or more sections of roadway length and one or more traffic lanes. The one or more sections of roadway length may be virtually delimited stretches of road and the one or more traffic lanes may correspond to one or more actual road lanes.

At operation 403, the navigation system may receive vehicle to vehicle (V2V) messages from the plurality of detected vehicles, each V2V message including location and lane of each detected vehicle. The navigation system may also receive speed information of each detected vehicle via the V2V message. The navigation system may also receive a timestamp indicating the time when each V2V message was sent. The navigation system may determine the location of each detected vehicle by at least one of: global positioning system (GPS) coordinates, assisted roadside unit localization techniques, and/or vehicle assisted localization techniques.

The density of traffic in the region surrounding the first vehicle can be determined based on a size of the vehicular network. In some embodiments, the size of the vehicular network may be determined by repeating gossiping, such as described hereinabove. For example, the navigation system may determine a first weight value of the first vehicle, receive a second weight value of another vehicle, and calculate a new weight value for the first vehicle by averaging the first weight value and the second weight value. The navigation system may repeat the determining, receiving, and calculating operations at a preconfigured interval and may derive a converged weight value by averaging last weight values of the first vehicle and the other vehicle calculated at the preconfigured interval. For example, the size of the vehicular network may be determined based on a number of detected vehicles and the converged weight value.

At operation 404, the navigation system may determine a desired target lane position for the first vehicle based on: (1) a traffic feature in a calculated route of the first vehicle and/or (2) the received V2V messages. The desired target lane position may be, for example, a threshold longitudinal position by which the first vehicle is to be or should be in the desired lane, for example to be able to safely take the exit. The navigation system may determine what instructions to issue, or at least when the navigation system will issue those instructions (as a function of time and/or distance from the target lane position or exit ramp), based partially on the received V2V messages, and/or based on micro traffic density as determined by a size of a vehicular network that may be determined by a GbA algorithm such as described hereinabove.

The V2V messages may include any messages transmitted in a vehicular network including a Sample message, an acknowledgement to the Sample message, a Weight_Exchange message, and/or a Weight_Exchange_Reply message. As disclosed above, the size of a vehicular network may be determined based on a number of vehicles, K, in a gossip group divided by a converged average weight value. The navigation system may determine the desired target lane position based on a relative speed of the first vehicle and the plurality of detected vehicles in different lanes. The exit may be at least one of: an intersection, an exit, and/or a toll booth.

At operation 405, the navigation system may provide a guidance alert based on the determined desired target lane position. The guidance alert may be in at least one of audible, visual, and/or vibration forms.

Representative Traffic Aware Turn Notification Message

In one representative embodiment, when a vehicle plans to change lanes or make a turn, the vehicle may broadcast a message to indicate to surrounding vehicles that the vehicle is about to change lanes or make a turn. Various approaches/operations to notify surrounding vehicles of such information may be implemented e.g., a beamforming approach and a probabilistic approach.

A beamforming operation may include a signal processing technique that allows for directional signal transmission and/or reception. If vehicles are equipped with communication hardware supporting beamforming, information on lane ID may be transmitted to (e.g., only to) the trailing vehicles in the two lanes involved with the lane change.

In other representative embodiments, alternatively or in combination with the above-beamforming approach/operation, a probabilistic approach/operation may be implemented, for example to assure or to better assure that the lane change notification reaches those vehicles for which the lane change notification is intended quickly. In a probabilistic approach/operation, a vehicle changing lanes may send the lane change notification message to L of its neighbors, where L is an integer and, for example is greater than the number of vehicles that it wishes to receive the lane change notification message. The L vehicles may retransmit the message to other vehicles. The higher the number L, the higher the probability that the message can be or will be correctly delivered to the desired recipients, and the lower the amount of time it can take for the message to be delivered to the desired recipients. The optimal value for L may be computed in other ways.

Representative Variations on the Solution

In some representative embodiments, when a size of a counter table is too large (e.g., equal to or larger than a size threshold), a part or a portion of the counter table may be sent at one time and different one or more parts or portions of the counter table may be sent subsequently at different times. In some embodiments, a counter table may include at least one column which represents lanes of vehicles, without a representation of longitudinal sections of roadway. It may be possible to reduce the amount of data that is to be transmitted in association with the exchanging of counter tables, by transmitting lane data (e.g., only lane data) or longitudinal section data (e.g., only section data) as opposed to full location data.

FIG. 5 is a flowchart illustrating another representative method in accordance with an embodiment. The navigation system of a first vehicle in a vehicular network may include a transmitter, a receiver, and a processor to provide an alert to change a target lane position based on an estimate of traffic density.

The navigation system may determine a first lane position (e.g., a current lane position) of the first vehicle at operation 501. To determine a lane positon, in some representative embodiments, in addition to or in lieu of GPS, vehicles may be equipped with multiple sensors, such as modular and/or stereo cameras, LIDAR (Light Detection and Ranging), a vehicle odometer and/or inertial measurement units (IMU). The measurements associated with the sensors may be integrated with GPS position or other location data and/or digital maps to provide positioning data accurate enough to allow a vehicle to detect the lane in which the vehicle is currently driving. In some representative embodiments, a consensus algorithm may be used that may allow nearby vehicles to adjust their GPS position by an offset that is computed in a distributed fashion by the vehicles, for example to achieve more accurate lane detection. In certain representative embodiments, speed of nearby vehicles may be compared to values of average speed for a lane (e.g., each lane), for example to better identify the lanes that the vehicles are located. The first lane position also may be determined by at least one of: GPS coordinates, assisted roadside unit localization techniques/operations, and/or vehicle assisted localization techniques/operations.

At operation 502, the navigation system may determine a target lane position for the first vehicle as a function of a navigation event point. The navigation system may determine the desired target lane position based on or further based on relative speed of the first vehicle and the plurality of detected vehicles in different lanes.

At operation 503, the navigation system may determine a distance to the navigation event point. The navigation event point may be at least one of: an intersection, an exit, and/or a toll booth.

At operation 504, the navigation system may determine an alert time based on an estimate of traffic density. The estimate of traffic density may be based on traffic conditions in lanes between the first lane position and the target lane position and the distance to the navigation event point. The navigation system may detect a plurality of vehicles in a region surrounding the first vehicle, receive vehicle to vehicle (V2V) messages from the plurality of detected vehicles and determine the traffic conditions based on one or more received V2V messages. The V2V messages (e.g., each V2V message) transmitted by one of the plurality of detected vehicles may include location, speed, and lane of the vehicle transmitting the V2V message.

The estimate of traffic density may be based on information indicated in a counter table. The navigation system may count a number of vehicles detected in one or more lanes (e.g., each lane) based on the received V2V messages. The navigation system may generate a counter table of the first vehicle based on the counted number of vehicles in the one or more lanes (e.g., each lane). The counter table disclosing including and/or indicating the location of vehicles surrounding the first vehicle including the lane that each surrounding vehicle is in. The navigation system may receive a counter table associated with one or more detected vehicles (e.g., of each detected vehicle) and may update the counter table of the first vehicle based on the received counter tables associated with the one or more detected vehicle.

The navigation system may determine the traffic density of a region surrounding the first vehicle based on a size of the vehicular network. The region may determine the size of the vehicular network based on a number of detected vehicles and a converged weight value. The region may be divided into one or more sections, the one or more sections comprising one or more longitudinal sections of roadway and one or more traffic lanes. The one or more longitudinal sections of roadway correspond to virtually delimited stretches of road and the one or more traffic lanes correspond to one or more actual road lanes. The navigation system may determine the converged weight value by repeating a gossiping process/operation between two vehicles among the first vehicle and the plurality of vehicles at a preconfigured interval. For the gossiping process/operation, the navigation system may determine a first weight value of a vehicle, receive a second weight value of another vehicle, and calculate a new weight value by averaging the first weight value and the second weight value.

At operation 505, the navigation system may provide an alert associated with the target lane position at an alert time. The type of alert may be in at least one of audible, visual, and/or vibration forms.

FIG. 6 is a flowchart illustrating a further representative method in accordance with an embodiment. At operation 601, the navigation system may determine a target lane position for the vehicle as a function of a traffic feature. The target lane position comprising a particular lane of a roadway and/or a longitudinal position in the roadway.

At operation 602, the navigation system may determine a distance to the traffic feature. In certain representative embodiments, the traffic feature may include at least one of: a merged lane, an express lane (e.g., for high occupancy or green vehicles), a train crossing, a pedestrian crossing, a gate, an entrance, a circle, an intersection, an exit, a cattle chute and/or a toll booth.

At operation 603, the navigation system may provide a navigational guidance alert to a driver of the vehicle at an alert time based on an estimate of traffic density based on traffic conditions in one or more lanes between a first lane position (e.g., current lane position) and the target lane position and the distance to the traffic feature. The navigation system may determine the traffic conditions in the one or more lanes between the first lane position and the target lane position based on a plurality of vehicle to vehicle (V2V) messages received from neighboring vehicles. The V2V messages (e.g., some or each of the V2V messages) may include a number of neighboring vehicles observed in the lanes (e.g., each lane) between the first lane position and the desired target lane position. The V2V messages (e.g., some or each of the V2V messages) may include a count of vehicles detected in neighboring lanes. The navigation system may determine the first lane position based on at least one of: global positioning system (GPS) coordinates, assisted roadside unit localization techniques/operations, and/or vehicle assisted localization techniques/operations.

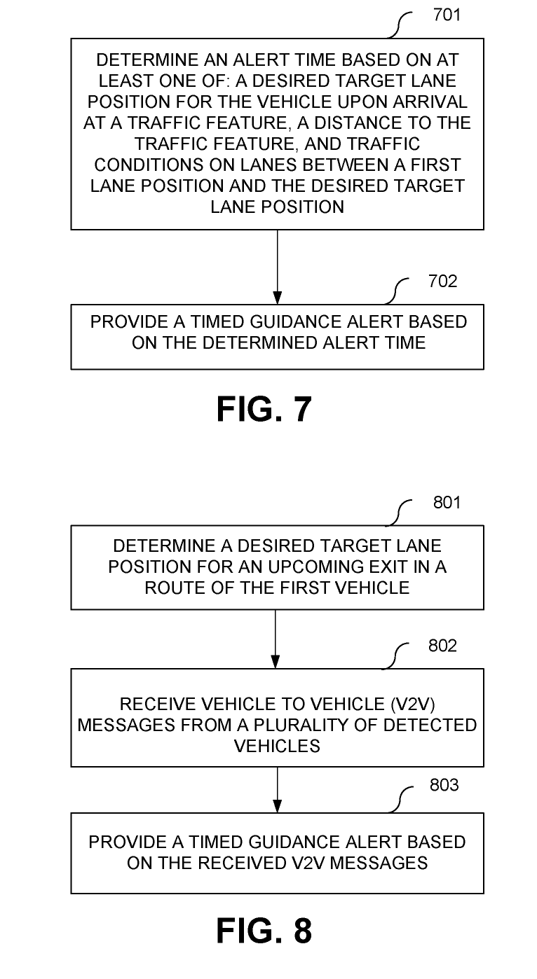

FIG. 7 is a flowchart illustrating an additional representative method in accordance with an embodiment. At operation 701, the navigation system may determine an alert time based on at least one of: a desired target lane position for the vehicle upon arrival at a traffic feature, a distance to the traffic feature, and/or traffic conditions on one or more lanes between a first (e.g., current) lane position and the desired target lane position. The navigation system may determine the traffic conditions on the one or more lanes between the first lane position and the desired target lane position based on at least one of: a plurality of vehicle to vehicle (V2V) messages received from neighboring vehicles and/or onboard vehicle sensors. The traffic feature may comprise at least one of: a merged lane, an express lane (e.g., for high occupancy or green vehicles), a train crossing, a pedestrian crossing, a gate, an entrance, a circle, an intersection, an exit, a cattle chute and/or a toll booth. The V2V message (e.g., each V2V message) may include a count of vehicles detected in neighboring lanes.

At operation 702, the navigation system may provide a timed guidance alert based on the determined alert time.

FIG. 8 is a flowchart illustrating a still further representative method in accordance with an embodiment. At operation 801, the navigation system may determine a desired target lane position for an upcoming exit in a route of the first vehicle.

At operation 802, the navigation system may receive vehicle to vehicle (V2V) messages from a plurality of detected vehicles, the V2V messages comprising information regarding per-lane vehicle count for one or more lanes between a first and/or current lane position and the desired target lane position for the upcoming exit.

At operation 803, the navigation system may provide a timed guidance alert based on the received V2V messages.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer readable medium for execution by a computer or processor. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU 102, UE, terminal, base station, RNC, or any host computer.

Moreover, in the embodiments described above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the representative embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (“RAM”)) or non-volatile (e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It is understood that the representative embodiments are not limited to the above-mentioned memories and that other platforms and memories may support the described methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost vs. efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

It is also to be understood that the terminology used herein is for the purpose of describing particular embodiments only, and is not intended to be limiting. As used herein, when referred to herein, the terms “station” and its abbreviation “STA”, “user equipment” and its abbreviation “UE” may mean (i) a wireless transmit and/or receive unit (WTRU), such as described infra; (ii) any of a number of embodiments of a WTRU, such as described infra; (iii) a wireless-capable and/or wired-capable (e.g., tetherable) device configured with, inter alia, some or all structures and functionality of a WTRU, such as described infra; (iii) a wireless-capable and/or wired-capable device configured with less than all structures and functionality of a WTRU, such as described infra; or (iv) the like. Details of an example WTRU, which may be representative of any UE recited herein, are provided below with respect to FIGS. 1-5.

In certain representative embodiments, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

The herein described subject matter sometimes illustrates different components contained within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of” multiples of the items and/or the categories of items, individually or in conjunction with other items and/or other categories of items. Moreover, as used herein, the term “set” or “group” is intended to include any number of items, including zero. Additionally, as used herein, the term “number” is intended to include any number, including zero.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth. Moreover, the claims should not be read as limited to the provided order or elements unless stated to that effect. In addition, use of the terms “means for” in any claim is intended to invoke 35 U.S.C. § 112, 6 or means-plus-function claim format, and any claim without the terms “means for” is not so intended.

A processor in association with software may be used to implement a radio frequency transceiver for use in a wireless transmit receive unit (WTRU), user equipment (UE), terminal, base station, Mobility Management Entity (MME) or Evolved Packet Core (EPC), or any host computer. The WTRU may be used m conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

Although the invention has been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although the invention is illustrated and described herein with reference to specific embodiments, the invention is not intended to be limited to the details shown. Rather, various modifications may be made in the details within the scope and range of equivalents of the claims and without departing from the invention.

Throughout the disclosure, one of skill understands that certain representative embodiments may be used in the alternative or in combination with other representative embodiments.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer readable medium for execution by a computer or processor. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WRTU, UE, terminal, base station, RNC, or any host computer.

Moreover, in the embodiments described above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits.

The data bits may also be maintained on a computer readable medium including magnetic disks, optical disks, and any other volatile (e.g., Random Access Memory (“RAM”)) or non-volatile (“e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It is understood that the representative embodiments are not limited to the above-mentioned memories and that other platforms and memories may support the described methods.

No element, act, or instruction used in the description of the present application should be construed as critical or essential to the invention unless explicitly described as such. In addition, as used herein, the article “a” is intended to include one or more items. Where only one item is intended, the term “one” or similar language is used. Further, the terms “any of” followed by a listing of a plurality of items and/or a plurality of categories of items, as used herein, are intended to include “any of,” “any combination of,” “any multiple of,” and/or “any combination of” multiples of the items and/or the categories of items, individually or in conjunction with other items and/or other categories of items. Further, as used herein, the term “set” is intended to include any number of items, including zero. Further, as used herein, the term “number” is intended to include any number, including zero.

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

A processor in association with software may be used to implement a radio frequency transceiver for use in a wireless transmit receive unit (WRTU), user equipment (UE), terminal, base station, Mobility Management Entity (MME) or Evolved Packet Core (EPC), or any host computer. The WRTU may be used m conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

Although the invention has been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although the invention is illustrated and described herein with reference to specific embodiments, the invention is not intended to be limited to the details shown. Rather, various modifications may be made in the details within the scope and range of equivalents of the claims and without departing from the invention.

1. A method of providing an alert by a navigation system of a first vehicle in a vehicular network, the method comprising:
determining a first lane position of the first vehicle;
determining a target lane position for the first vehicle as a function of a navigation event point;
determining a distance of the first vehicle to the navigation event point;
determining an alert time based on an estimate of traffic density, wherein the estimate of traffic density is based on traffic conditions in one or more lanes between the first lane position and the target lane position and the distance of the first vehicle to the navigation event point; and
providing an alert associated with the target lane position at the alert time.

2. The method of claim 1, further comprising:
detecting a plurality of other vehicles in a region surrounding the first vehicle; and
receiving vehicle to vehicle (V2V) messages from at least one of the plurality of detected vehicles, each of the received V2V messages including location information, speed information and lane information that is associated with a corresponding one of the detected vehicles.

3. The method of claim 2, further comprising determining the traffic conditions based on the V2V messages.

4-5. (canceled)

6. The method of claim 1, further comprising:
determining the estimate of the traffic density based on a size of the vehicular network.

7. The method of claim 2, wherein the region surrounding the first vehicle is divided into one or more sections, the one or more sections comprising one or more longitudinal sections of roadway and one or more traffic lanes.

8-9. (canceled)

10. The method of claim 1, further comprising:
determining a converged weight value by repeating a gossiping process between two vehicles among the first vehicle and the plurality of vehicles,
wherein the gossiping process comprises:
determining a first weight value of the first vehicle;
receiving a second weight value of another vehicle of the plurality of vehicles; and
calculating a new weight value by averaging the first weight value and the second weight value.

11. The method of claim 1, wherein the determining of the first lane position includes determining global positioning system (GPS) coordinates using any of: a GPS, a GPS with assisted roadside unit localization, or a GPS with vehicle assisted localization.

12. The method of claim 2, wherein the determining the target lane position is based on a relative speed of the first vehicle and the plurality of vehicles detected in lanes different from the lane of the first vehicle.

13. The method of claim 1, wherein the alert is in at least one of audible, visual, or vibration forms.

14. The method of claim 1, wherein the navigation event point is at least one of: an intersection, an entrance, an exit, or a toll booth.

15. A navigation system of a first vehicle providing a guidance alert, the navigation system comprising:
a transmitter;
a receiver; and
a processor, coupled to the transmitter and the receiver, configured to:
determine a first lane position of the first vehicle;
determine a target lane position for the first vehicle as a function of a navigation event point;
determine a distance to the navigation event point;
determine an alert time based on an estimate of traffic density, wherein the estimate of traffic density is based on traffic conditions in lanes between the first lane position and the target lane position and the distance to the navigation event point; and
provide an alert associated with the target lane position at the alert time.

16. The navigation system of claim 15, wherein the processor is further configured to:
detect a plurality of vehicles in a region surrounding the first vehicle; and
receive vehicle to vehicle (V2V) messages from the plurality of detected vehicles, wherein each V2V message from each detected vehicle includes location, speed and lane of the respective detected vehicle.

17. The navigation system of claim 16, wherein the processor is further configured to determine the traffic conditions based on the V2V messages.

18-19. (canceled)

20. The navigation system of claim 15, wherein the processor is further configured to determine the estimate of traffic density based on a size of the vehicular network.

21. The navigation system of claim 20, wherein the region is divided into one or more longitudinal sections, the one or more sections comprising one or more longitudinal sections of roadway and one or more traffic lanes.

22-23. (canceled)

24. The navigation system of claim 15, wherein the processor is further configured to determine the converged weight value by repeating a gossiping process between two vehicles among the first vehicle and the plurality of vehicles at a preconfigured interval,
wherein the processor is further configured to perform gossiping process by:
determining a first weight value of a vehicle;
receiving a second weight value of another vehicles; and
calculating a new weight value by averaging the first weight value and the second weight value.

25. The navigation system of claim 15, wherein the processor is further configured to determine the first lane position using at least one of: global positioning system (GPS) coordinates, assisted roadside unit localization, or vehicle assisted localization techniques.

26. The navigation system of claim 16, wherein the processor is configured to determine the desired target lane position further based on relative speed of the first vehicle and the plurality of detected vehicles in different lanes.

27. The navigation system of claim 15, wherein the alert is in at least one of audible, visual, or vibration forms.

28. The navigation system of claim 15, wherein the navigation event point is at least one of: an intersection, an exit, or a toll booth.
